(19) United States
(12) Patent Application Publication
(10) Pub. No.: US 2003/0217223 A1
(43) Pub. Date: Nov. 20, 2003

(54) Combined command set

(75) Inventors: Leonel R. Nino JR., Raleigh, NC (US); Torsten Partsch, Chapel Hill, NC (US); Jennifer F. Huckaby, Raleigh, NC (US); Catherine Bosch, Apex, NC (US)

Correspondence Address: David W. Okey, Brinks Hofer Gilson & Lione, P.O. BOX 10395, CHICAGO, IL, 60610, US

(73) Assignee: Infineon Technologies North America Corp.

(21) Appl. No.: 10/145,760

(22) Filed: May 14, 2002

(51) Int. Cl. G06F 12/00

(52) U.S. Cl. 711/105; 711/5; 711/157

(57) ABSTRACT

A circuit and method of operation for combining commands in a DRAM (dynamic random access memory) are revealed. The method applies to DRAMs having a plurality of memory banks or arrays. The method combines commands to rows on different memory banks, and the method also combines row and column commands on different memory banks. The method eliminates steps in a sequence of commands, and may significantly increase speed of input/output to a DRAM.

### FIELD OF THE INVENTION

The present invention relates generally to the field of random access memories (RAMs), and more particularly the present invention relates to dynamic random access memories (DRAMs).

### BACKGROUND OF THE INVENTION

Dynamic random access memories (DRAMs) are used extensively in electronic circuits, especially in circuits requiring large amounts of memory in a high speed computing environment. The personal computer is likely the greatest market for these circuits, but other markets also exist, from telecommunications, to Internet and electronic-commerce applications, to graphics and publishing. Whatever the application, users and manufacturers constantly seek to improve both computers and their memories, looking for improvements in everything from software to hardware to better interactions between the two.

One area for improvement is speeding up individual operations in all aspects of reading, writing and refreshing the memory cells of the arrays in a DRAM. Particularly advantageous would be speeding up any operations that are known to be “slow” or bottlenecks in computing capacity, Also advantageous are those changes in which a hardware change is not required, or in which a minimal hardware change is required. Hardware changes are typically changes to the traces of transistors or hard-wired logic circuits in the DRAM or its component parts. Operations that are slower may be those involving a long sequence of commands such as a series of read and write commands to a plurality of memory locations in a DRAM. These memory locations may be on different “arrays” or banks within a DRAM, or they may on the same array or bank.

In order to help speed circuit operation, CMOS technology, typically used for DRAMs, has improved from 0.26 micron to 0.19 micron, and now down to 0.14 micron spacing between traces, with 0.11 micron spacing under development. Closer traces and smaller sizes allow for more memory density in a given area or volume. Closer traces also speed up the processing for memory input and output, as the electrical impulses travel shorter and shorter distances. Concurrent operation of a certain few steps also helps, but these concurrent steps are limited to row precharge and activation sequences. These efforts help, but more could be done to speed up processing of inputs and outputs to and from the DRAM, and within the DRAM itself. What is needed is a way to speed up the operation of dynamic random access memories (DRAMs), making them faster than ever before to keep up with the need for faster and faster required computing speeds.

### BRIEF SUMMARY

Embodiments of the present invention meet this need by providing an apparatus and a method for a faster dynamic random access memory. One embodiment of the invention is a dynamic random access memory (DRAM). The DRAM has at least two memory banks and a logic circuit connected to the at least two memory banks. The DRAM combines commands to the at least two banks, the commands selected from the group consisting of row/row commands and row/column commands.

Another embodiment of the invention is a method of operating a dynamic random access memory (DRAM). The method includes providing a DRAM having at least two memory banks. The method then includes combining commands to the at least two memory banks, the commands selected from the group consisting of row commands and column commands to at least two memory banks, and row commands to at least two memory banks. Many other embodiments and aspects of the invention are also possible.

### BRIEF DESCRIPTION OF SEVERAL VIEWS OF THE DRAWINGS

FIG. 1 is a block diagram of a computer or microprocessor.

FIG. 2 is a block diagram of a dynamic random access memory.

FIG. 3 is a flow chart of a prior art command sequence.

FIG. 4 is a flow chart of a combined command sequence according to the present invention.

FIG. 5 is a timing diagram for the command sequence in an embodiment of the present invention.

FIG. 6 is a prior art truth table set of commands.

FIG. 7 is a mode register set for the present invention.

FIG. 8 is a prior art state diagram for a DRAM.

FIG. 9 is a simplified state diagram for command sequences according to an embodiment of the present invention.

### DETAILED DESCRIPTION OF THE PRESENTLY PREFERRED EMBODIMENTS

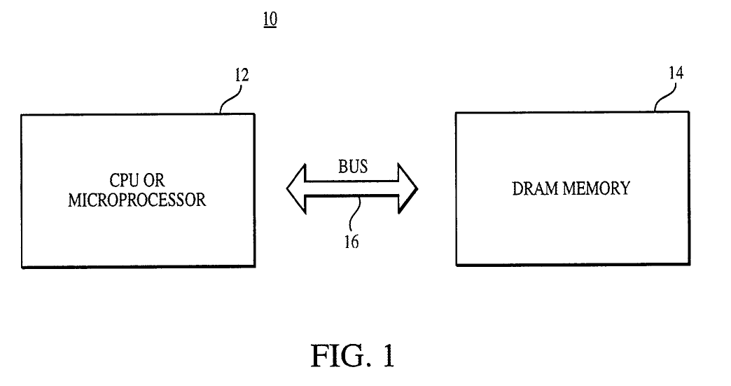

FIG. 1 depicts a computer 10, having a computer processing unit (CPU) or microprocessor controller 12. The CPU 12 calls on a memory, such as a DRAM memory 14, to store information via a communication bus 16. The CPU is also available to retrieve information for use by the CPU. In order for the computer to work at high speed, it is essential that the memory in the DRAM can store and retrieve information at a very fast rate. In order for a fast flow of information, it is necessary that the DRAM can write and read (store and retrieve) information at a very high rate of speed.

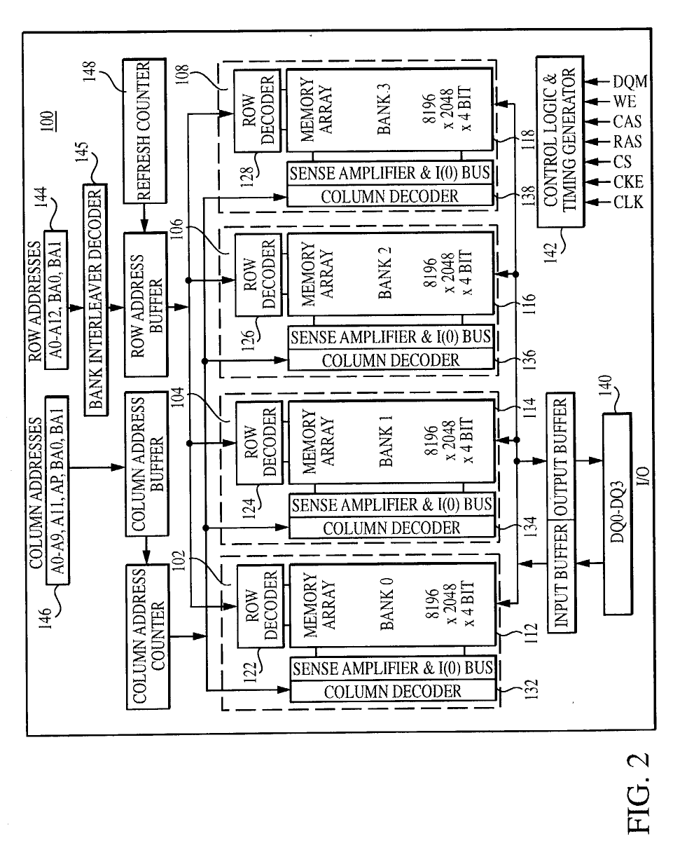

FIG. 2 depicts a CMOS dynamic random access memory (DRAM) 100. This memory is a 64 Megabit×4 synchronous DRAM, having an array of four memory arrays 102, 104, 106 and 108. Each array is capable of storing 8192×2048×4 bits of memory. Each array has a respective memory bank or array 112, 114, 116 and 118, as well as a row decoder 102, 104, 106 and 108, and a column decoder 132, 134, 136, 138. Also included within the DRAM are input/output circuits 140, control logic and timing 142, row address circuitry 144, and column address circuitry 146. There may also be a refresh counter 148 for the periodic refreshing necessary for DRAM circuits.

The control circuitry of the DRAM 100 controls the four memory arrays 102, 104, 106 and 108, as well as the memory banks 112, 114, 116, 118, as well as the row decoders and column decoders of the memory banks. In particular, row decoder 122 and column decoder 132 communicate with and control first bank memory array 112, in response to signals from the row and column address circuitry of DRAM 100. In a similar manner, second bank memory array 114 receives control signals from row decoder 124 and column decoder 134, and so on for each memory array. Each memory array receives commands from the row decoder and column decoder associated with that memory array, for every operation involving reading, writing, and refreshing the memory cells of the DRAM.

Row address control circuitry 144 and column address control circuitry 146 control all the operations for reading and writing to each memory bit in DRAM 100. The timing and sequence of operations of each memory array is governed by signals generated from the control logic and timing generator 142. The control logic and timing generator 142 is in communication with the row and column address control circuitry 144, 146 relaying commands to the memory arrays. The necessary connecting circuitry is not shown for clarity in the figure. Commands are ultimately relayed to each memory array and the row and column decoders for each array. In addition, the DRAM of FIG. 2 is equipped with an interleaver/deinterleaver 145 for combining commands to more than one bank. Bank interleaving for the rows may be accomplished by any convenient means, including a buffer, an address multiplexer, and an addition or subtraction from the bank address. Examples may include a first-in first-out buffer, or an address multiplexer that allows sequential or ordered addressing of banks of a DRAM. Another example may be an algorithm that decodes a bank address, using techniques such as addition, subtraction or other transformation to determine an address.

Certain commands may take longer than others to execute. For example, the command “precharge,” from the row decoder requires each row in the array and each transistor in each wordline, to turn off, one at a time, in series. This operation is also known as a wordline “pulldown,” that is, turning off each transistor in the series of transistors that constitutes a wordline or “row”. In this embodiment, there are 8192 rows and 2048 columns in each memory array 112, 114, 116, 118 shown in FIG. 2. Therefore, each row has 2048 transistors and each column has 8192 transistors, in series.

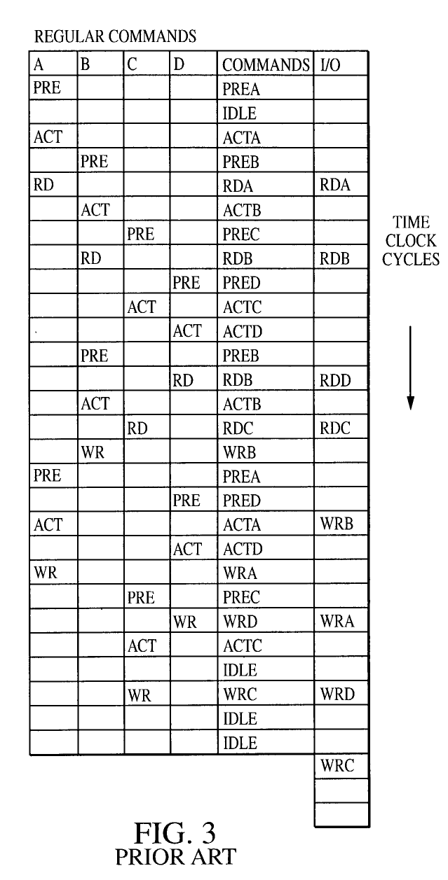

FIG. 3 depicts a prior art sequence of commands to a DRAM having 4 memory banks, A, B, C, and D. The particular sequence sought in the process according to FIG. 3 is to read and write only to a particular location (row and column) in each bank, such as, Read A, Read B, Read C and Read D, followed by Write A, Write B, Write C and Write D. Idle time, in which no operation is being performed, is depicted as a blank box. In order to accomplish these tasks, 31 command clock cycles are needed. At 125 MHz, each command takes about 8 ns, so 31 steps require about 248 ns. The sequence depicted in FIG. 3 reads vertically, with each row depicting a discrete step or period of time. In addition, idle sequences may be required in certain steps, in accordance with the operating rules of the particular DRAM and the need to accommodate certain buffering operations and the like. In the embodiment depicted in FIG. 3, the time period to read or to write is two clock cycles.

Commands used frequently in operation of a DRAM include no operation, also known as NOP or idle. This command prevents unwanted commands from being registered during idle or wait states, and does not affect operations already in progress. An active command is used to open or activate a row in a particular bank for a subsequent access. The row remains active until a precharge command, or a read with auto precharge, or a write with auto precharge, is issued to that row in that bank. The precharge command, or read or write with auto precharge, is issued and completed before opening a different row in the same bank. The precharge command is used to deactivate or close an open row in one bank or in all banks. Once a bank or a row has been precharged, it is in an idle state and is be activated prior to any read or write commands. An auto precharge is a feature that performs the precharge function with requiring an explicit command.

A read command is used to initiate a burst read access to an open row. If auto precharge has also been selected, the row being accessed is precharged (closed) at the end of the read burst. If auto precharge has not been selected, the row remains open for subsequent access. A write command is used to initiate a burst write access to an open row. If auto precharge has also been selected, the row being accessed is precharged (closed) at the end of the write burst. If auto precharge has not been selected, the row remains open for subsequent access. Input data appearing on the input for the bank is written to the memory array, if the DRAM logic is consistent for writing the data, rather than ignoring the data.

Other parameters for the example of FIG. 3 include a burst length of two. A burst length is the maximum number of column locations that can be accessed for a given read or write command. Column address strobe (CAS) latency is also specified as 2 clock cycles. This means that there is a delay of 2 clock cycles between registering a read command and the availability of the first burst of output data. Other parameters in this embodiment include a write recovery time of 2 clock cycles, precharge command period of 2 clock cycles, and a delay period of 2 clock cycles for active bank A to active bank B commands. Active to precharge command requires 6 clock cycles. Normally, a read or a write operation may occur while the row is open. Active to active timing within a wordline with auto-refresh requires 9 clock periods, which means simply that to write twice to a bit in the same wordline requires 9 clock periods.

The right-hand side of FIG. 3 also has columns that summarize the commands given (“COMMANDS”) and the input/output of the DRAM is shown under the column “I/O”. Time periods when there is no command being carried out and no input or output is occurring are termed “idle” or “delay” time. Thus, in FIG. 3, 31 steps of time are required to read once and write once to a single row of each of the four arrays, A, B, C and D.

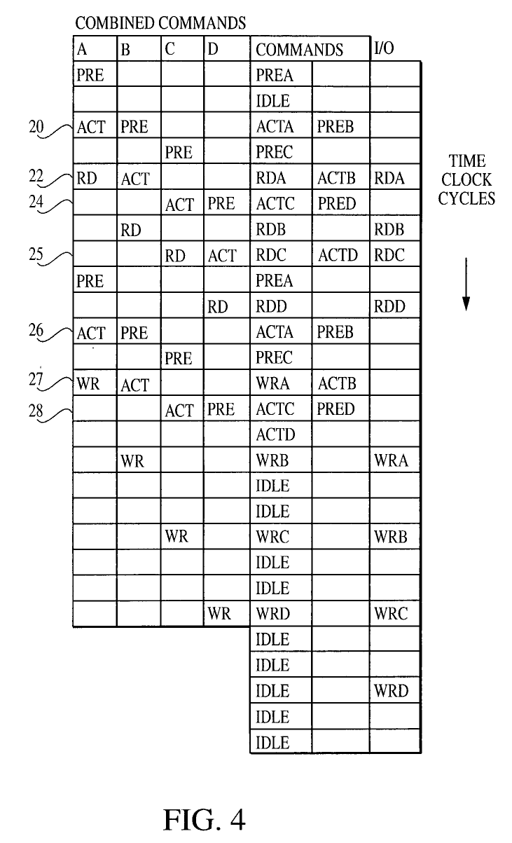

FIG. 4 depicts a combined command embodiment in which each bank in the memory array is read from one time and written to one time. These are the same operations that were performed in FIG. 3, and thus the advantages of the combined commands may be seen in the fewer clock cycles taken to complete the operations, that is, 27 clock cycles in FIG. 4 rather than 31 clock cycles in FIG. 3. The same latency and operational periods described above for FIG. 3 apply to FIG. 4. FIG. 4 is arranged in a manner similar to FIG. 3, with commands to each bank under the column headings, A, B, C and D. There are now two columns labeled “COMMANDS” because more than one command may be given at once. Input/output to the DRAM is noted under the “I/O” column. Commands to more than one row at a time are called row/row commands and commands to a row and a column at the same time are called row/column commands.

In this example, commands are combined, as seen in command sequences 20, 22, 24, 25, 26, 27 and 28. Idle time is again depicted by blank boxes. In sequence 20, a combined row command is given to two different banks, activate A and precharge B. The command will be given to the same or different rows in both A and B. In sequence 22, a column command to one bank is combined with a row command to another bank, Read A and Activate B. In the next sequence 24 a combined command is given to Activate C and Precharge D, that is, to activate a particular row in bank C and precharge that same row or a different row in bank D. Note that the sequence used for reading or writing is not changed from “precharge,” “activate,” and then “read” or “write.” Time is saved by combining commands as shown. If more read and write operations were in progress in FIG. 4, what appears as primarily idle time (blank boxes) would have more combined operations and more time would be saved. As it is in this sequence, the four read and write operations consume 27 command clock cycles, or about 216 ns at 125 MHz (8 ns per command cycle). This saves about 32 ns, about a 15% speed-up of this particular read/write operation for the DRAM of FIG. 2. Other data input/output operations may save more or less time depending on the actual operations needed and taken.

In order to implement a combined command DRAM, certain modifications should be made to the control logic used for operating DRAMs. Until now, commands were typically issued one-at-a-time, rather than combining commands, with the exception of unique situations such as an “auto-precharge” or “precharge all,” commanding rows only to more than one bank, or write with auto-precharge, combining row and column commands on the same bank. By contrast, embodiments of the present invention combine commands either to rows in multiple banks, or to rows and columns in multiple banks.

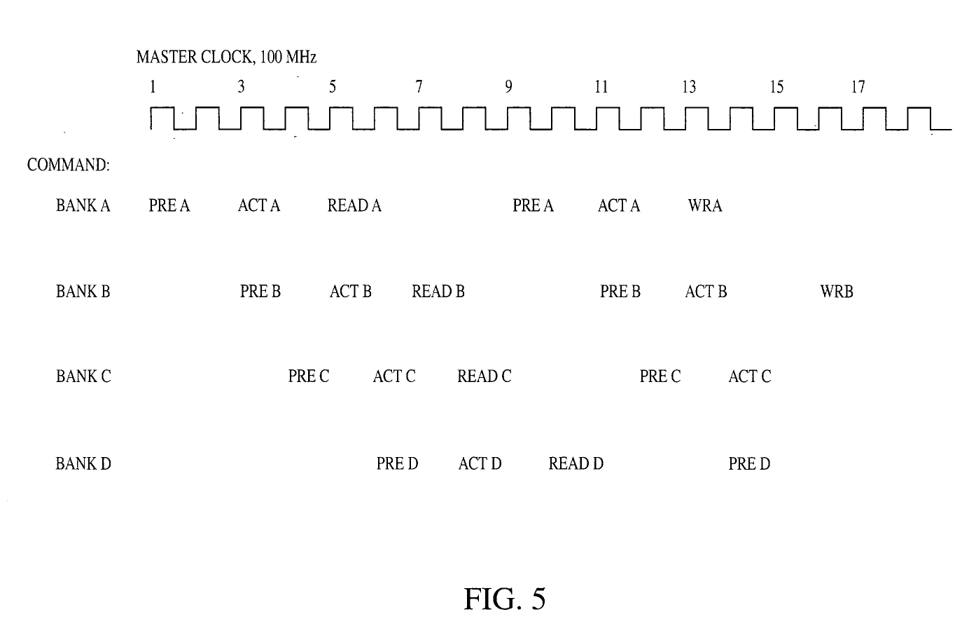

FIG. 5 illustrates the timing of the commands of the embodiment of FIG. 4, using a clock sequence running at about 100 MHz. At clock cycle 1, the command is given to precharge A (“Pre A”). With a required time lapse, Bank A can only be activated (“Act A”) at cycle 3. At the same time, however, a combined command is given to precharge B (“Pre B”), saving at least one clock cycle. At clock cycle 4, the command is to precharge C (“Pre C”), followed at clock cycle 5 with a combined command to read A (“Rd A”) and activate B (“Act B”), and so on. FIG. 5 depicts seven combined commands, at clock cycles 3, 5, 6, 8, 11, 13 and 14. The latency and buffering requirements are the same in FIG. 5 as in FIGS. 3 and 4. Other embodiments may have other latency or buffer requirements or rules. Combining commands will also shorten the periods for read/write cycles in other embodiments.

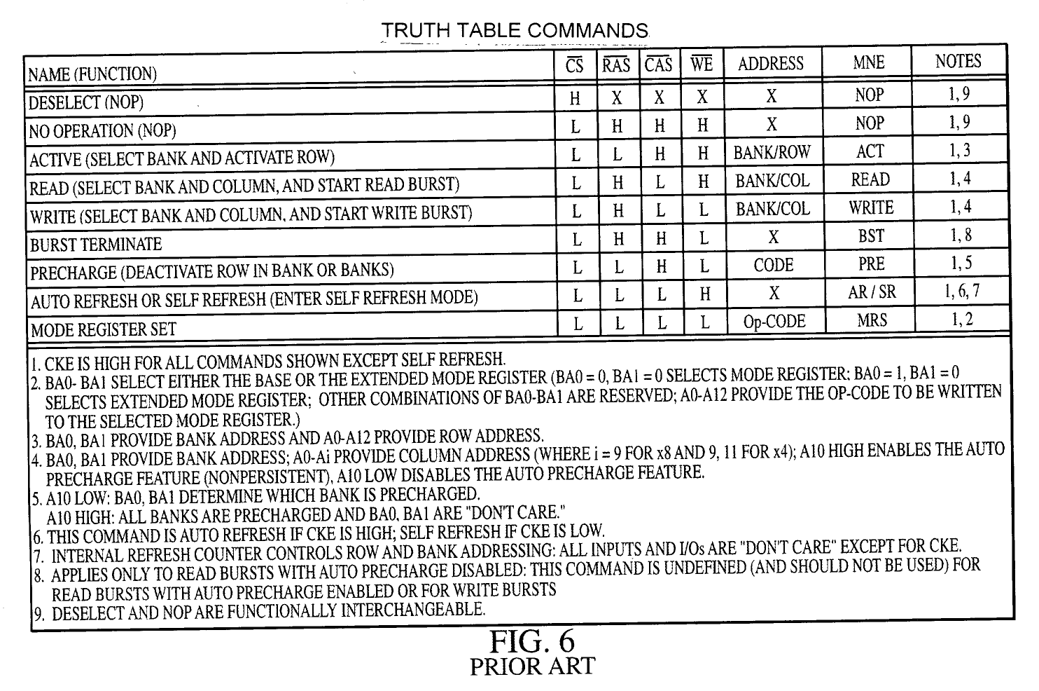

FIG. 6 illustrates a truth table with the situation for the logic with respect to the control signals of a DRAM. The truth table provides a set of rules by which the DRAM operates, including the latency periods and delay periods mentioned above for FIGS. 3-5. With 4 gates and two states (high or low), there should be 16 possible states for four command signals. The four command signals include chip select, CS, that is, which of the four banks in this embodiment is selected for an operation. Another command RAS, row address strobe, selects a wordline for an operation. The command CAS, column address strobe, selects a bit line or column, for an operation. The fourth command is write enable, WE, which enables both read and write to a bit. In some instances, however, the CS high state may actually pre-empt all operations by invoking a deselect or “no operation” state. FIG. 6 reveals another possibility, namely the “no operation” line, which is redundant with the “deselect” line. However, using this redundancy may be confusing in view of hardware and operations manuals already in use. What is needed is a logic state that clearly and unambiguously indicates that the new combined commands are invoked.

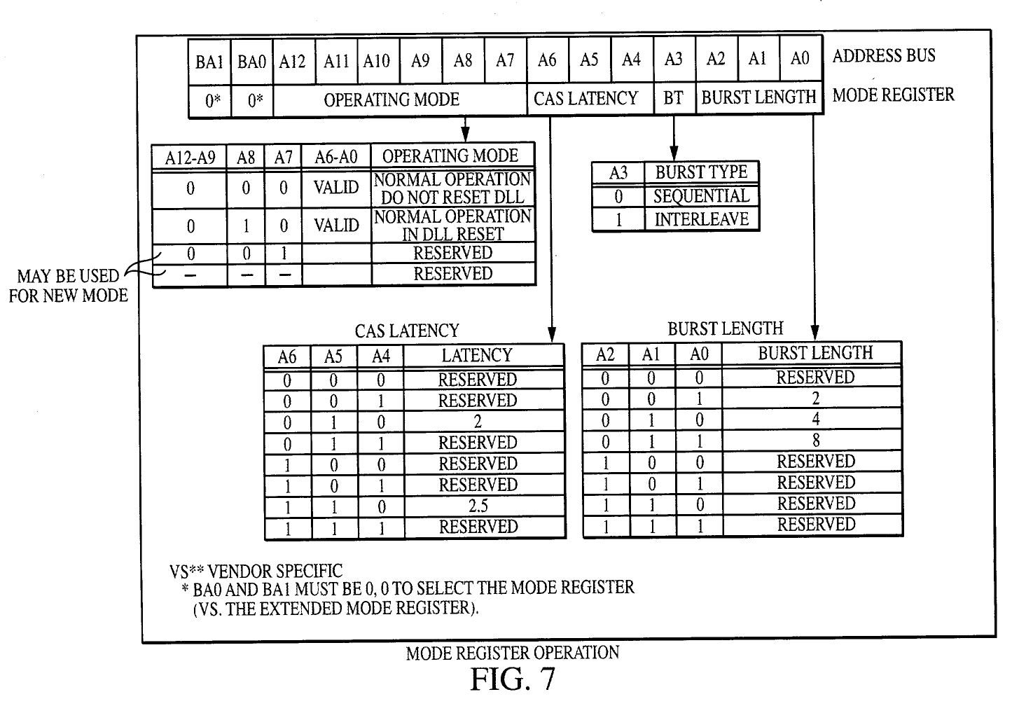

A mode register operation according to one embodiment is depicted in FIG. 7. The mode register is used to define the specific mode of operation of a DRAM. The mode register is programmed via a mode register set command (with BA0=0 and BA1=0) and retains the stored information until it is programmed against or the device loses power. In this embodiment, mode register bits A0-A2 specify the burst length, A3 specifies the type of burst (sequential or interleaved), A4-A6 specify the CAS latency, and A7-A12 specify the operating mode. The mode register is loaded when the DRAM banks are idle, and the controller waits a specified time before initiating a subsequent operation. Burst length may be defined as the maximum number of column locations that can be accessed for a given read or write command.

In the embodiment shown, for an Infineon HYB25D256400/800AT 256 Mbit double data rate synchronous DRAM, there are several “reserved” or unused logic states available. Any of these logic states may be designated for a “combined command” state. For instance, when mode register bits A8-A12 are low or “0”, and A7 is high or “1”, that state may designate the “combined command” state. Thus, when bit A7 is high and bits A8 through A12 are low, the combined command state is indicated. The combined commands indicated in FIG. 4 will be enabled, and the DRAM will combine commands as shown in FIGS. 4 and 5.

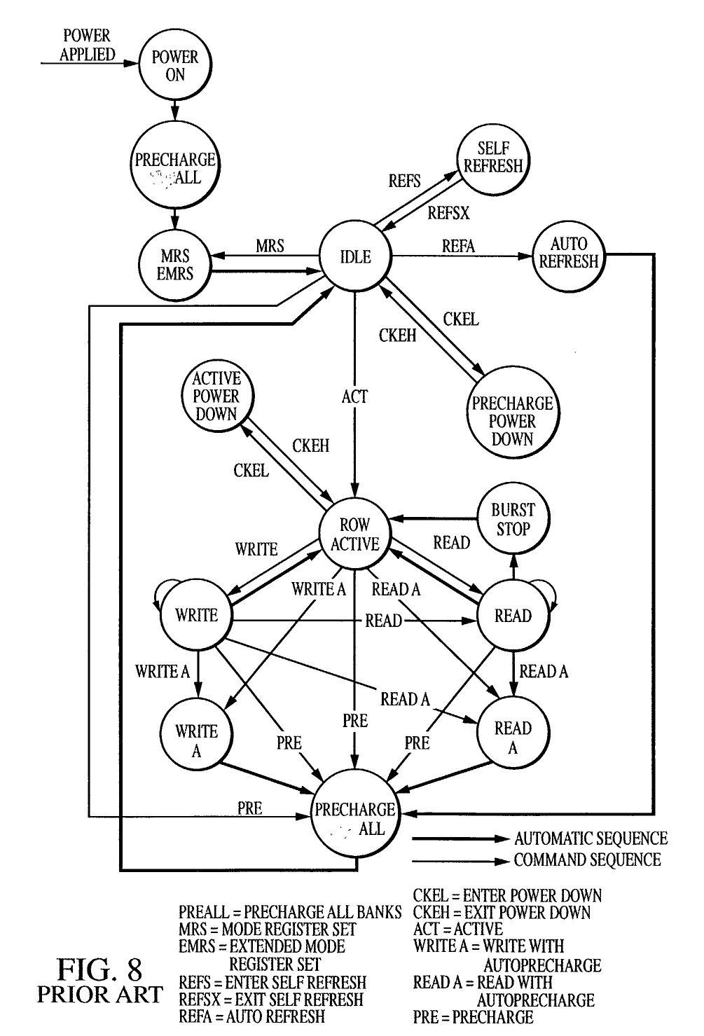

A simplified state diagram for a DRAM showing the context in which a mode register set (MRS) appears is depicted in FIG. 8. This state diagram corresponds to the mode register set shown in FIG. 6. The command sequences allowed in the DRAM depend on the state of the mode register set switches, that is, the states of the CS, RAS, CAS, and WE switches or gates, as shown in the mode register set. In the nodes having more than one “next step,” the next step taken depends on the states switches or gates set by the mode register. Thus, upon power-up, a DRAM will turn power on and precharge all banks, that is, to close all rows. The DRAM will then acknowledge a mode register set or extended mode register set, depending on which is used, before proceeding to an IDLE state. Once the IDLE state has been reached, all the other operations of a DRAM may begin, as shown in the state diagram. Each state or node represents a command, and the nodes connected to a node are the possible commands before or after that command. Only the connected commands are possible. For instance, before any step of reading or writing is possible, a command of Act or activate is given to activate or open a row. The row may then be read to, written to, or closed (precharged). Note that the commands “Read A” and “Write A” are different from “Read” and “Write”, in that the former include an auto precharge command. Combined commands according to the present embodiments are not possible with the prior art mode register set or the prior art state diagram, as shown in FIGS. 6 and 8.

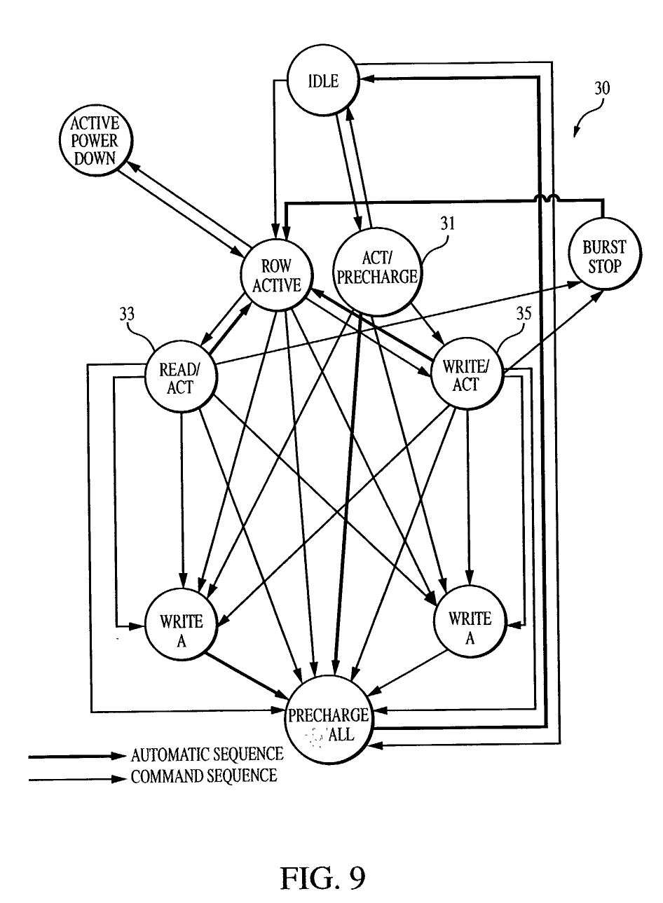

FIG. 9 presents a simplified state diagram for a DRAM embodiment according to the present invention. The sequences depicted in FIG. 9 are in addition to those sequences already available in FIG. 8. Setting the mode register to allow the “Combined Command” sequences allows activation of the sequences in FIG. 9. Command sequences for Activate/Precharge 31, Read/Activate 33, and Write/Activate 35 have been explicitly added. No options that were previously available have been removed, and the new command sequences that were added illustrate the additional options available when commands are combined. FIG. 9 is a simplified state diagram, and does not illustrate all aspects of the invention, especially timing, for which FIG. 5 may provide a better illustration.

Although only a few embodiments of the invention have been discussed, other embodiments are contemplated. For example, non-throughput row commands may be interleaved with combined commands to increase data throughput to a memory device. Such an embodiment utilizes the data bus more effectively through combined commands. It is therefore intended that the foregoing description illustrates rather than limits this invention, and that it is the following claims, including all equivalents, which define this invention. Of course, it should be understood that a wide range of changes and modifications may be made to the embodiments described above. Accordingly, it is the intention of the applicants to protect all variations and modifications within the valid scope of the present invention.

What is claimed is:

1. A dynamic random access memory, comprising:
at least two memory banks; and
a control logic and timing circuit connected to the at least two memory banks, wherein the dynamic random access memory combines commands to the at least two banks, the commands selected from the group consisting of row/row commands and row/column commands.

2. The dynamic random access memory of claim 1, wherein the commands combined are selected from the group consisting of read and activate, write and activate, and activate and precharge.

3. The dynamic random access memory of claim 1 wherein the commands combined are to activate a row of a first memory bank and precharge the same row of a second memory bank.

4. The dynamic random access memory of claim 1, wherein the commands combined are to read or write to a column of a first bank, and to activate a row of a second bank.

5. A dynamic random access memory, comprising:
at least two memory banks, each memory bank having a plurality of rows and columns;
a control logic and timing circuit connected to the at least two memory banks; and
an interleaver for the dynamic random access memory, wherein the interleaver combines row commands to the at least two memory banks.

6. The dynamic random access memory of claim 5, wherein the interleaver comprises at least one of a buffer, an address multiplexer, and hardware storing an algorithm for coding or decoding a row address.

7. A dynamic random access memory, comprising:
at least two memory banks, each memory bank having a plurality of rows and columns, and a row decoder and a column decoder;
a control logic and timing system connected to the at least two memory banks; and
an interleaver for the dynamic random access memory, wherein the interleaver combines row commands to the at least two memory banks.

8. The dynamic random access memory of claim 7 wherein the interleaver comprises at least one of a buffer, an address multiplexer, and hardware storing an algorithm for coding or decoding a bank address.

9. A method of operating a dynamic random access memory (DRAM), the method comprising:
providing a DRAM having at least two memory banks; and
combining commands to the at least two memory banks, the commands selected from the group consisting of row commands and column commands to at least two memory banks, and row commands to at least two memory banks.

10. The method of claim 9 further comprising controlling the combining of commands by selecting a mode.

11. The method of claim 9 further comprising interleaving of commands, said interleaving controlled by a method selected from the group consisting of buffering the commands, multiplexing the commands, coding the commands from a bank address and decoding commands to a bank address.

12. A method of operating a dynamic random access memory (DRAM), the method comprising:
providing a DRAM having at least two memory banks; and
combining commands to the at least two memory banks, the commands selected from the group consisting of a row/row command and a column/row command.

13. The method of claim 12, wherein a command to activate a row in a first memory bank is combined with a command to precharge a row in a second memory bank.

14. The method of claim 12, wherein a command to read to a column in a first memory bank is combined with a command to activate a row in a second memory bank.

15. The method of claim 12, wherein a command to write to a column in a first memory bank is combined with a command to activate a row in a second memory bank.
